(19) United States
(12) Patent Application Publication
(10) Pub. No.: US 2006/0025522 A1
(43) Pub. Date: Feb. 2, 2006

(54) High solids primer composition based on thermal initiated free-radical polymerization

(76) Inventors: Jeffery W. Johnson, Rochester Hills, MI (US); Donald Albert Paquet JR., Troy, MI (US); Peter William Uhlianuk, Romeo, MI (US); San C. Yuan, Commerce Township, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/903,089

(22) Filed: Jul. 30, 2004

(51) Int. Cl. C08G 63/91

(52) U.S. Cl. 525/10

(57) ABSTRACT

This invention relates to a thermosetting primer composition having a low VOC content useful in the manufacture of automobiles and trucks in which the film-forming binder comprises a thermal polymerization initiator and an addition-polymerizable ethylenically unsaturated monomer which serves a dual function of solvent and binder polymer formed in situ on thermal curing to deliver low VOC and desired rheological and physical properties. These primers are especially useful in reducing emissions, while also meeting today's performance requirements, such as ease of application and excellent physical properties such as corrosion resistance, a high level of adhesion to primed and unprimed substrates, and provide a surface to which conventional automotive topcoats will adhere.

### FIELD OF THE INVENTION

This invention is directed to a primer composition and in particular to a high solids primer having a low VOC content (volatile organic content) primarily useful for automobiles and trucks.

### BACKGROUND OF THE INVENTION

Primer compositions are well known in the art and are widely used in the manufacture of automobiles and trucks as shown in Simon U.S. Pat. No. 4,232,090 issued Nov. 4, 1980. In recent years, to meet the increasingly demanding regulations to reduce emissions or VOC content of automotive coatings, high-solids primers have been developed that contain less solvents, but still have sprayable viscosities and can be applied with conventional equipment. For instance, high-solids polyester primers are shown in Ambrose et al. U.S. Pat. No. 4,535,132 issued Aug. 13, 1985 and in Willey U.S. Pat. No. 5,023,141 issued Jun. 11, 1991. High-solids photopolymerizable compositions have also been proposed which have more elaborate application requirements, such as the need for exposure to actinic light. However, none of these compositions meet the current needs of modern automotive and truck manufacturing plants which require high solids compositions that have a low VOC but that also can be applied with conventional equipment in present day paint facilities and have excellent physical properties such as corrosion resistance and a high level of adhesion to primed and unprimed metal substrates, primed and unprimed plastic substrates and provide a surface to which conventional topcoats will adhere.

It would be advantageous to have a high-solids primer composition with this unique combination of properties.

### SUMMARY OF THE INVENTION

The present invention provides a high-solids or low solvent thermosetting primer composition having a solids content of at least 80% by weight, based on weight of total coating composition, comprising a film-forming binder and preferably pigments in a pigment to binder ratio of about 1:100-150:100; wherein the binder contains:
(a) an addition-polymerizable, ethylenically unsaturated compound capable of forming a high polymer by free-radical initiated addition polymerization;
(b) a thermal polymerization initiator;
wherein (a) and (b) total 100% by weight of the binder.

Advantageously, despite the presence of addition-polymerizable compound(s), no actinic light, such as UV or EB light, is required to effect curing of the composition. Since the present invention does not rely on light initiated curing, the composition is uniquely suited to work in present day automotive and truck assembly plants because ovens are already in place to initiate the free radical polymerization and curing on the substrate.

Optionally, the binder may include (c) a crosslinking agent, such as a monomeric or polymeric alkylated melamine formaldehyde crosslinking agent, that is reactive with functional groups built onto component (a) to provide for additional crosslinking through condensation type reactions. If condensation type reactions are utilized in the coating on curing, such coatings will not be able to achieve 100 percent solids, since in most cases minor amounts of organic volatiles will be emitted on curing.

The present invention also contemplates the use of coatings having up to 100 percent solids content (i.e., approaching 0 VOC content). Even at such high solids levels, the coatings have sufficient low viscosity so as to enable easy application such as by spraying, etc., without the need to employ appreciable amount of solvent.

The invention is based on the discovery that use of certain thermal polymerization initiators and low molecular weight polymerizable compounds in the binder, in place of the traditional film-forming polymer, provide compositions having sprayable viscosities and desired low VOC, and also deliver a hard, tough, and durable finish with excellent physical properties within a short period of time after application.

Also included within the scope of this invention is a substrate, such as a vehicle body or part thereof, coated with the primer coating composition disclosed herein.

The present composition is especially useful as a primer surfacer when finishing automotive and truck exteriors.

### DETAILED DESCRIPTION OF THE INVENTION

The primer composition is high-solids and has a low VOC content (volatile organic content), can be formulated into a pigmented composition, forms finishes that are hard, have excellent adhesion to a variety of substrates such as cold rolled steel, phosphatized steel, phosphatized steel primed with a primer applied by electrocoating, plastic substrates which may be primed or unprimed such as polyester reinforced fiber glass, reaction injection molded urethanes, partially crystalline polyamides and other plastic substrates and provides a surface to which conventional topcoats will adhere.

The primer composition is particularly useful on the aforementioned substrates since it can be used as a surfacer to cover imperfections in surfaces of primed metal and plastic substrates. For example, electrocoating of metal substrates with a primer often results in a finish that has small imperfections and this composition can be applied to form a smooth, glossy finish that is free from imperfections. Also, plastic substrates such as SMC (sheet molding compound) which is a polyester reinforced with fiber glass contain many surface imperfections and must be coated with a surfacer. By increasing the pigmentation used in the composition, an easily sandable finish is formed that covers imperfections and can be sanded to a smooth finish which is then topcoated with conventional acrylic enamel finishes.

A particular advantage of the novel coating composition of this invention is that it has a low VOC content, i.e., a VOC content of less than 0.24 kilogram of organic solvent per liter (2 pounds per gallon) of composition. The novel coating composition can readily be formulated to have a VOC of less than 0.12 kg per liter (1 pound per gallon), which is most desirable.

The VOC of the coating is determined in accordance with the procedure provided in EPA Method 24.

In order to achieve such low VOC, the primer composition of this invention is formulated as a high-solids composition containing little or no volatile organic solvents. “High solids composition” as used herein means a coating composition having a total solids concentration of at least 80 percent, preferably of at least 90 percent, in weight percentages based on the total weight of the composition. It should by understood that “total solids” refers to the total amount of non-volatile components in the composition even though some of the components may be non-volatile liquids rather than solids at room temperature. Such compositions are able to be formulated with less solvents than conventional primers, while still having sufficient low viscosity so as to enable easy application without having to employ an appreciable amount of volatile solvents. Even in absence of solvent, these compositions are usually a flowing liquid at room temperature that can be applied with conventional equipment located in automobile and truck assembly plants.

In accordance with the forgoing, the present composition typically only contains up to about 20% by weight of a volatile organic liquid carrier, which usually is a solvent for the binder, preferably up to about 10% by weight.

The film-forming portion of the primer coating composition of this invention is referred to as the “binder” or “binder solids”. The binder in the present invention typically makes up about 50-95% of the total solids present in the composition. Generally, catalysts, pigments, and non-polymeric chemical additives such as stabilizers are not considered part of the binder solids. Non-binder solids other than pigments usually do not amount to more than about 5-10% by weight of the composition. In this disclosure, the term binder includes the addition-polymerizable compound, thermal initiator, and all other optional film-forming polymers and/or crosslinking agents.

The film-forming binder of the coating composition of this invention suitably contains about 55-99% by weight of one or more addition-polymerizable ethylenically unsaturated compound(s) and 1-5% by weight of a thermal polymerization initiator, and 0-40% by weight of an optional monomeric or polymeric alkylated melamine formaldehyde crosslinking agent. One preferred composition contains about 78% by weight of addition-polymerizable compound(s), 2.0% by weight of thermal initiator, 20% of monomeric or polymeric alkylated melamine formaldehyde crosslinking agent.

The addition-polymerizable compounds used in the composition are ethylenically unsaturated monomers and/or oligomers that are capable of forming a high polymer by thermal free-radical initiated chain-propagating addition polymerization. Typically, such compound is a monomer, dimer, or short chain oligomer having ethylenic unsaturation, particularly vinyl, acrylate or methacrylate-ethylenic unsaturation, preferably compounds having an ethylenic unsaturation functionality of 2 or greater, i.e., di- or polyunsaturated compounds containing at least two ethylenically unsaturated groups per molecule. Some monounsaturated compounds can be used herein such as isobornyl acrylate. However, monounsaturated compounds are typically avoided unless they contain an additional reactive site, since without such site they are normally much too toxic and too volatile to be spray applied.

Optionally, the ethylenically unsaturated monomer can have reactive functional groups built therein, in addition to the polymerizable group(s), such as a hydroxyl, silane, carbamate group, capable of reacting on curing through condensation reactions with itself and/or with a melamine component or other crosslinking/film-forming component in the composition for additional crosslinking and improved toughness of the finish and shorter curing times.

It is generally desired that the addition-polymerizable compounds in accordance with the invention are nongaseous compounds having a boiling point above 100° C. at atmospheric pressure and have a number average molecular weight (Mn) of about 300-3,000.

Molecular weight is determined by gel permeation chromatography using polymethyl methacrylate as the standard.

While not wishing to be bound by theory, the inclusion of such compounds in the binder is believed to serve a dual function, namely that of solvent as well as in situ binder polymer for the coating system to deliver low VOC and desired rheological and physical properties.

The addition-polymerizable compounds are typically used in amounts from about 55-99 by weight, preferably 60-80%, and more preferably 78% by weight, based on the weight of the binder.

Examples of diunstaurated monomers suitable for use herein are: diacrylates and dimethacrylates such as alkylene glycol di(meth)acrylate, polyethylene glycol di(meth)acrylate, 1,3-butane diol di(meth)acrylate, vinyl (meth)acrylate, allyl (meth)acrylate, divinyl benzene, dipropylene glycol di(meth)acrylate, tripropylene glycol di(meth)acrylate, 1,6-hexanediol di(meth) acrylate, and alkoxylated diol diacrylates such as propoxylated neopentyl glycol diacrylate. Examples of polyunsaturated monomers are: triacrylates and trimethacrylates such as glycerine tri(meth)acrylate, trimethylolpropane tri(meth)acrylate, pentaerythritol tri(meth)acrylate, pentaerythitol tetra(meth)acrylate, or higher. Also useful are low molecular weight oligomers such as (meth)acrylate terminated urethane oligomers, e.g., low molecular polyurethanes prepared from trimers of diisocyanates and hydroxy functional alkyl methacrylates; (meth)acrylate terminated epoxy oligomers; and (meth)acrylate terminated polyester oligomers, e.g., low molecular weight polyesters can also be used which have been acrylated through either transesterification, or through post reaction of epoxy containing acrylates or methacrylates, such as glycidyl acrylate or glycidyl methacrylate, and pendant acid groups on the polyester. By “low molecular weight” for this component, it is meant no more than about 3000 (number average). One preferred urethane oligomer is the adduct of the isocyanurate of hexamethylene diisocyanate with two moles of monoaliphatic alcohol (generates two carbamate reactive sites) and one mole of hydroxy functional (meth)acrylate. Also useful are (meth)acrylate terminated urethane oligomers prepared from hydroxy functional (meth)acrylates such as those described in U.S. Pat. No. 5,744,282.

Of course, mixtures of the above-mentioned compounds are also suitable for use herein.

To initiate in situ polymerization of the monomers on curing of the coating, the primer coating contains a thermal initiator system comprising at least one thermal initiator. The thermal polymerization initiator used in the composition is a thermal free radical initiator. Typically, the thermal initiator is present in the composition in sufficient amount to effect polymerization of the addition-polymerizable components on thermal curing of the composition. Typically this means an amount ranging from about 1-5% by weight, preferably 2.0%, based on the weight of the binder. Any of the conventional azo or peroxide type polymerization initiators can be used, provided it has solubility in the coating solution, and has an appropriate half life at the temperature of polymerization of the radically polymerizable component. “Appropriate half life” as used herein is a half life of about 10 to 30 minutes. Peroxy based thermal initiators are preferred, since these materials are liquid at room temperature at atmospheric pressure. Examples of peroxy based thermal initiators are are benzoyl peroxide, lauryl peroxide, dicumyl peroxide, t-butyl peroxy(2-ethyl hexanoate), t-butyl peroxyacetate, t-butyl peroxypivalate, t-butyl peroctoate, t-amyl peroctoate, and cumene hydrogen peroxide. Examples of azo type initiators which can also be used are as 2,2′-azobis (isobutyronitrile), 2,2′-azobis (2,4-dimethylvaleronitrile), 2,2′-azobis (methylbutyronitrile), and 1,1′-azobis (cyanocyclohexane).

It is possible to rely entirely on the above two components as the main film-forming components in the coating of this invention. Such compositions can be formulated to be true 100% solids coatings, provided the viscosity is such that the coating composition can readily be applied. However, for suitable cross-link density and sufficiently short curing times, most primer compositions in conjunction with the present invention contain an additional crosslinking agent which has at least two reactive sites that are capable of reacting with functional groups built into the monomer. Generally, the crosslinking agent will be used in amounts from about 0-40% by weight, preferably 20% by weight, based on he weight of the binder.

The crosslinking agent typically used in the composition is a polymeric or monomeric partially or fully alkylated melamine formaldehyde crosslinking agent. Preferably, the crosslinking agent is fully alkylated. Useful crosslinking agents are methylated, butylated or isobutylated melamine formaldehyde resins that have a degree of polymerization of about 1-3. Such crosslinking agents typically have a number average molecular weight of about 500-1,500. Mixtures of these crosslinking agents can also be used. The crosslinking agents may also be blocked or unblocked polyisocyanates containing greater than two isocyanate unblocked or blocked groups.

Additionally, the coating composition of this invention can include a number of other ingredients as are known in the art to enhance preparation of the composition as well as improve final properties of the coating composition and the finish. For example, it is often desirable to include additional low molecular weight film-forming binder polymers and/or oligomers and/or crosslinking agents and/or reactive diluents in the binder in conjunction with the above-mentioned components, preferably in the range of 0 to 45% by weight, based on the weight of the binder. Examples of other film-forming polymers and/or oligomers include acrylic polyols, acrylourethanes, acrylosilanes, polyester polyols, polyester urethanes, polyethers, polyether urethanes, and polyurethane polyols that are compatible with the other components of the binder. One particularly preferred class of film forming polymers are silane functional acrylic oligomers containing one or more hydrolyzable silane groups, such as alkoxy silane functional acrylosilane polymers, that are reactive with themselves and the hydroxyl groups of the polyester and/or monomer to provide for additional crosslinking and a hard, tough, durable finish within a short period of time after application. Additional crosslinking agents, for example any of the conventional polyisocyanate crosslinking agents, may also be used. Typically useful reactive diluents include low molecular weight polyester polyols, silicates, urethane diols, and cycloaliphatic diepoxides. By “low molecular weight” for this component, it is meant no more than about 3000 (number average).

Typical pigments that can be used in the composition are filler pigments such as talc, china clay, barytes, carbonates, silicates, metallic oxides such as titanium dioxide, zinc oxide and iron oxide and carbon black and organic colored pigments and dyes. The resulting primer composition has a pigment to binder weight ratio of about 1:100-150:100. A pigment to binder ratio of 75:100 is generally preferred.

The pigments can be introduced into the primer composition by first forming a mill base with the polyester copolymer or with another compatible polymer or dispersant by conventional techniques such as sand grinding, ball milling or attritor grinding. The mill base is blended with other constituents used in the composition.

Any of the conventional solvents or blends of solvents can be used as the organic liquid carrier, if needed, to disperse and/or dilute the above ingredients to form the primer composition, provided that the selection of solvents is such that the polymeric binder constituents are compatible and give a high quality primer. The following are examples of solvents that can be used to prepare the composition: methyl ethyl ketone, methyl amyl ketone, methyl isobutyl ketone, toluene, xylene, acetone, ethylene glycol monobutyl ether acetate and other esters, ethers, ketones and aliphatic and aromatic hydrocarbon solvents that are conventionally used.

In one particularly preferred primer composition, the binder contains about 24% by weight, based on the weight of the binder, of a hydroxyl-containing (meth)acrylate terminated urethane oligomer which is acrylated dipropylene glycol urethane oligomer; 55% by weight, based on the weight of the binder, of a diunsaturated (meth)acrylate monomer which is propoxylated diacrylate; and 19% by weight, based on the weight of the binder, of a monomeric fully alkylated melamine formaldehyde crosslinking agent, which is methylated, butylated and/or isobutylated. The composition forms a hard cured coating on a substrate having excellent adhesion to the substrate and forms a smooth finish to which conventional topcoats can be applied.

The composition can also contain about 0.1-5% by weight, based on the weight of the binder, of ultraviolet light stabilizers which term includes ultraviolet light absorbers, screeners and quenchers. Typical ultraviolet light stabilizers include benzophenones, triazines, triazols, benzoates, hindered amines and blends of thereof.

In addition, a composition according to the present invention can contain a variety of other optional ingredients, including plasticizers, surfactants, flow control agents, for example, such as Resiflow® (polybutylacrylate), BYK® 320 and 325 (high molecular weight polyacrylates), rheology control agents such as fumed silica, water scavengers, and the like.

The primer composition can be applied to a plastic or metal substrate by conventional techniques such as spraying, electrostatic spraying, dipping, brushing, flowcoating and the like. As mentioned above the preferred method is electrostatic spraying. After application, the composition is baked at about 120-200° C. for about 5-45 minutes to form a primer coating layer about 0.1-2.0 mils thick. Generally the primer layer is about 0.5-1.5 mils thick.

To achieve faster cure of the composition, particularly in conjunction with the optional crosslinking agent, a catalyst can be added to catalyze the crosslinking of reactive components present in the composition. Typical of such catalysts are sulfonic acids, such as dodecylbenzene sulfonic acid, either blocked or unblocked, are effective catalysts. Useful blocked acid catalysts are dodecyl benzene sulfonic acid blocked with an amine, such as amino methyl propanol or dimethyl oxazolidine. Other useful catalysts will readily occur to one skilled in the art. Preferably, these catalysts are used in the amount of about 0.1 to 5.0%, based on the weight of the binder.

Conventional solvent based or water based acrylic enamels or lacquers, acrylic polyurethane coatings, polyesterurethane coatings, alkyd enamels and the like can be applied by electrostatic spraying over the primer and then baked to form a durable automotive or truck finish.

As indicated above, the present composition is especially useful as a primer surfacer when finishing the exterior of automobile and truck bodies and parts thereof. The present composition, depending on the presence of pigments and other conventional components, can also be used during finishing as a primer, monocoat, basecoat, and/or an unpigmented or slightly pigmented clearcoat.

The following example illustrates the invention. All parts and percentages are on a weight basis unless otherwise indicated. Molecular weights are determined by gel permeation chromatography using polymethyl methacrylate as the standard.

### Testing Procedures Used in the Examples

Hardness—Tukon Hardness—test method ASTM D1474—a rating of at least 6 is an acceptable minimum.

60° Gloss—test method ASTM D523—a rating of at least 80 is an acceptable minimum.

Adhesion—the adhesion of 0 to 5 was determined in accordance with test method ASTM D3359—a rating of at least 4 B is an acceptable minimum.

Chip Resistance—the chip resistance was determined utilizing a gravelometer and follows the procedure described in test method SAEJ400—a rating of at least 5 is an acceptable minimum.

### EXAMPLE 1

A white color primer surfacer composition was prepared by mixing together the following ingredients in a suitable mixing vessel in the order shown:

| Components | Parts by weight |
|---|---|
| Acrylated urethane functional | 120 |
| oligomer¹ (100% NV) | |
| Propoxylated (NPG) diacrylate² (100% | 280.5 |
| NV) | |
| Polyacrylate surface additive³ (10% | 6.2 |
| NV) | |
| Monomeric fully methylated melamine | 30.0 |
| formaldehyde⁴ (99.8% NV) | |
| White pigment dispersion⁵ | 221.5 |
| Acid catalyst solution⁶ | 2.6 |
| T-butyl peroxy(2-ethyl hexanoate)⁷ | 10.86 |
| Total | 671.66 |

Table Footnotes
In this Table, the abbreviation “% NV” stands for % by weight non-volatile content or % by weight solids content.
¹100% solids of an oligomer of Desmodur ® N-3300 (Bayer Corporation, Pittsburgh, Pa)/Dowanol ® PNP glycol ether (Dow Chemical, Midland, MI)/4 hydroxybutyl acrylate in an equivalent ratio of 3/2/1. This oligomer is then mixed in a weight ratio of 80/20 Cymel ® 301 from Cytec Industries Inc., West Patterson, New Jersey.
²SR9003 propoxylated (2) neopentyl glycol diacrylate supplied by Sartomer, Exton, Pa.
³Disparlon ® LC-955 supplied by King Industries, Norwalk, Conneticut.
⁴Cymel ® 1133 monomeric melamine supplied by Cytec Industries Inc., West Patterson, New Jersey
⁵68% solids of titanium dioxide pigment dispersed in 29% solids of melamine and 3% weight of pigment dispersing agent which is 79% NV.
⁶25% organic sulfonic acid blocked with 2-methyl-1 propanol.
⁷Luperox ® 26 t-butyl peroxy ethylhexanoate peroxide initiator supplied by Atofina, Philadelphia, Pennsylvania.

The resulting primer surfacer composition has a theoretical solid content of 98% and a viscosity of 43 seconds measured with # 4 Ford cup. The analytical spray weight solids is 80-86%. This primer has a VOC at the range of 1.0-1.4 lbs/gal.

The surfacer was applied by spraying a layer onto a phosphatized steel panel coated with a cured cathodic epoxy resin based electrodeposition primer. The primed panel was air flash dried for 5-10 minutes and baked at 150° C. for 30 minutes to form a layer about 25-32 micron dry. The primed panel was then topcoated with a commercially available automobile pigmented solventborne basecoat at 20-30 micron and wet on wet with acryosilane clear coating composition (Gen IV ES from DuPont Company, Wilmington, Del.). Flashed dried for 10 minutes and baked for 30 minutes at 140° C.

The coatings on the panel had the following properties:

| Primer only (Example 1) | | | Primer (example 1) plus white | |
|---|---|---|---|---|
| | Gloss | | topcoat | |
| Tukon | (60degree) | Adhesion | Chip**(SAE J400) | Adhesion |
| 8.0 Knoop | 92 | 5(No failure) | 6A | 5(No failure) |

**Chip number rating 6 = 10-24 chips per standard area; A = diameter of chips less than 1 mm.

The above results show that it is possible to formulate a high quality baking primer surfacer suitable for automotive applications, having a VOC below 2.0 lbs/gallon and excellent adhesion and chip resistance.

Various other modifications, alterations, additions or substitutions of the component of the compositions of this invention will be apparent to those skilled in the art without departing from the spirit and scope of this invention. This invention is not limited by the illustrative embodiments set forth herein, but rather is defined by the following claims.

What is claimed is:

1. A thermosetting primer composition having a solids content of at least 80% by weight, based on weight of total coating composition, comprising a film-forming binder and pigments in a pigment to binder ratio of about 1:100-150:100; wherein the binder contains:
(a) an addition-polymerizable, ethylenically unsaturated compound capable of forming a high polymer by free-radical initiated addition polymerization;
(b) a thermal polymerization initiator;
wherein (a) and (b) total 100% by weight of the binder.

2. The primer composition of claim 1 wherein the binder further contains
(c) a melamine crosslinking agent;
wherein (a), (b) and (c) total 100% by weight of the binder.

3. The primer composition of claim 1 having a VOC content of less than 0.24 kilogram of organic solvent per liter (2 pounds per gallon).

4. The primer composition of claim 1 wherein the solids content is at least about 90%.

5. The primer composition of claim 1 comprising up to about 20% by weight based on total weight of said composition of volatile organic liquid carrier.

6. The primer composition of claim 1 in which the thermal polymerization initiator is a thermal peroxide initiator.

7. The primer composition of claim 1 in which the polymerizable monomer has at least two polymerizable unsaturated groups per molecule.

8. The primer composition of claim 2 in which the polymerizable monomer has at least one polymerizable unsaturated group and at least one other group capable of reacting with itself and/or (c).

9. The primer composition of claim 1 in which the polymerizable monomer is selected from the groups consisting of diacrylates, dimethacrylates, triacrylates, trimethacrylates, and mixtures thereof.

10. The primer composition of claim 2 in which the polymerizable monomers contain crosslinking functional groups reactive with itself and/or (c).

11. The primer composition of claim 1 in which the melamine crosslinking agent is a monomeric methylated, butylated, and/or isobutylated melamine formaldehyde.

12. A substrate coated with a dried and cured layer of the composition of claim 1.

13. The substrate of claim 12 in which the substrate is a metal.

14. The substrate of claim 12 in which the substrate is a plastic.

15. The substrate of claim 12 in which the substrate is a plastic reinforced with fiberglass.

16. The substrate of claim 12 in which the substrate is a vehicle body or part thereof.

17. The primer composition of claim 1, wherein the composition is a primer surfacer for a vehicle.

18. A primer composition having a solids content of at least 80% by weight, based on weight of total coating composition and a VOC of less than 0.24 kilogram of organic solvent per liter (2 pounds per gallon), comprising a film-forming binder and pigments in a pigment to binder ratio of about 1:100-150:100; wherein the binder contains about:
(a) 55-99% by weight, based on the weight of the binder, of an addition-polymerizable, ethylenically unsaturated monomer having a number average molecular weight of about 300-3,000;
(b) 1-5% by weight, based on the weight of the binder, of a thermal peroxide polymerization initiator; and,
(c) 0-40% by weight, based on the weight of the binder, of a monomeric or polymeric alkylated melamine formaldehyde crosslinking agent;
wherein (a), (b) and (c) total 100%.

19. A thermosetting coating composition having a solids content of at least 80% by weight, based on weight of total coating composition, comprising a film-forming binder and optional pigments; wherein the binder contains:
(a) an addition-polymerizable, ethylenically unsaturated compound capable of forming a high polymer by free-radical initiated addition polymerization;
(b) a thermal polymerization initiator;
wherein (a) and (b) total 100% by weight of the binder.
